(19) United States
(12) Patent Application Publication
(10) Pub. No.: US 2020/0256091 A1
(43) Pub. Date: Aug. 13, 2020

(54) LATCH ASSEMBLY FOR AIRCRAFT MONUMENT

(71) Applicant: BOMBARDIER INC., Dorval (CA)

(72) Inventors: Michael RICCI, Montréal (CA); Andreea TANASE, Ried im Innkreis (AT); Wilfried KONRAD, Ried im Innkreis (AT)

(21) Appl. No.: 16/642,437

(22) PCT Filed: Aug. 28, 2018
(86) PCT No.: PCT/CA2018/051033

§ 371 Date: Feb. 27, 2020

Related U.S. Application Data
(60) Provisional application No. 62/552,042, filed on Aug. 30, 2017.

(51) Int. Cl. E05B 65/10; B64D 11/00; E05B 15/02; E05B 17/00; E05B 65/46

(52) U.S. Cl. CPC E05B 65/1026; B64D 11/00; B64D 11/04; E05B 17/0062; E05B 65/46; E05B 15/022

(57) ABSTRACT

A latch assembly for selectively preventing a relative movement between first and second components of an aircraft cabin monument, including a latch having a first connection member and a striker plate having a second connection member complementary to and selectively engageable with the first connection member. The engaged latch and striker plate in use are subjected to a load having a use threshold value and a decompression threshold value. The striker plate is designed to have a failure load higher than the use threshold value and lower than the decompression threshold value. The latch has a failure load higher than the use threshold value and higher than the decompression threshold value. A method of tailoring a failure of a latch assembly selectively preventing a relative movement between first and second components of an aircraft cabin monument is also discussed.

### CROSS-REFERENCE TO RELATED APPLICATION(S)

This International PCT Patent Application relies for priority on U.S. Provisional Patent Application Ser. No. 62/552,042 filed on Aug. 30, 2017, the entire content of which is incorporated herein by reference.

### TECHNICAL FIELD

The application relates generally to latch assemblies and, more particularly, to latch assemblies for monuments installed in aircraft cabins.

### BACKGROUND OF THE ART

Monuments in an aircraft cabin typically include latch assemblies which maintain the monument in a closed configuration, for example by retaining a drawer or door in its closed position. The latch assembly must resist the loads produced by the contents of the monument during flight.

In some aircraft configurations, it may be desirable for the monuments to open upon decompression of the cabin, so as to allow the equalization of the delta pressure. However, failure of a latch is hard to predict, due to the numerous interacting elements defining the latch mechanism. Tests must typically be performed to ensure that the latch remains intact during normal use but fails during decompression. These tests can be time consuming and expensive to conduct, and must often be repeated or re-done when an element of the latch is changed, for example due to a customer request, upon detection of a defect during use, or for aesthetic changes.

### SUMMARY

In one aspect, there is provided a latch assembly for selectively preventing a relative movement between first and second components of an aircraft cabin monument, the latch assembly comprising: a latch configured for connection to the first component, the latch having a first connection member; and a striker plate configured for connection to the second component, the striker plate having a second connection member complementary to the first connection member and selectively engageable with the first connection member; wherein the engaged latch and striker plate in use are subjected to a load having a use threshold value determined based on a movable mass of the monument and on accelerations generated by predetermined flight conditions, and having a decompression threshold value determined based on decompression pressure conditions; wherein the striker plate is designed to have a predetermined first failure load corresponding to a value of the load upon failure of the striker plate when the first engagement member is subjected to the load, the first failure load being higher than the use threshold value and lower than the decompression threshold value; and wherein the latch has a second failure load corresponding to a value of the load upon failure of the latch when the second engagement member is subjected to the load, the second failure load being higher than the use threshold value and higher than the decompression threshold value.

In particular embodiments, the latch assembly may include any one or any suitable combination of the following:
the striker plate has an opening defined therethrough, the striker plate including at least one zone of weakness adjacent the opening, the at least one zone of weakness determining the first failure load;
the first connection member of the latch is a latch bolt movable with respect to a housing of the latch, and the second connection member of the striker plate has the opening defined therethrough, the latch bolt engageable within the opening;
the opening in the striker plate is configured for receiving a fastener for connecting the striker plate to the second component of the monument;
the opening is defined adjacent an edge of the striker plate, the striker plate including an edge portion extending between the edge and the opening, the at least one zone of weakness including two spaced apart zones of weakness defined at opposed ends of the edge portion. Each of the two spaced apart zones of weakness may be defined by a notch in the striker plate, each notch extending from the opening to the edge of the striker plate;
the at least one zone of weakness includes a portion of the striker plate having a thickness smaller than a thickness of a remainder of the striker plate;
the at least one zone of weakness includes a portion of the striker plate having a cross-sectional area smaller than a cross-sectional area of a remainder of the striker plate, the cross-sectional areas being defined in a plane containing a thickness of the striker plate.

In another aspect, there is provided a latch assembly for selectively preventing a relative movement between first and second components of an aircraft cabin monument, the latch assembly comprising: a latch configured for connection to the first component, the latch having a housing and a latch bolt movable with respect to the housing; and a striker plate configured for connection to the second component, the striker plate having an opening defined therethrough, the latch bolt selectively receivable and engageable within the opening; wherein each of the latch and striker plate has a respective failure load with respect to a load transferred to the latch and striker plate when the latch bolt is engaged in the opening and the first and second components are forced away from each other; wherein the striker plate has at least one zone of weakness designed to determine the failure load of the striker plate; and wherein the failure load of the striker plate is smaller than the failure load of the latch.

In particular embodiments, the latch assembly may include any one or any suitable combination of the following:
the opening is defined adjacent an edge of the striker plate, the striker plate including an edge portion extending between the edge and the opening, the at least one zone of weakness being adjacent the opening;
the at least one zone of weakness includes two spaced apart zones of weakness defined at opposed ends of the edge portion;
each of the two spaced apart zones of weakness is defined by a notch in the striker plate, each notch extending from the opening to the edge of the striker plate;
the at least one zone of weakness includes a portion of the striker plate having a thickness smaller than a thickness of a remainder of the striker plate;
the at least one zone of weakness includes a portion of the striker plate having a cross-sectional area smaller than a cross-sectional area of a remainder of the striker plate, the cross-sectional areas being defined in a plane containing a thickness of the striker plate.

In a further aspect, there is provided a method of tailoring a failure of a latch assembly selectively preventing a relative movement between first and second components of an aircraft cabin monument, the method comprising: determining a use threshold value of a load applied to the latch assembly during predetermined flight conditions based on a movable mass of the monument and on accelerations generated by the predetermined flight conditions; determining a decompression threshold value of the load applied to the latch assembly based on decompression pressure conditions; selecting a latch of the latch assembly for connection to the first component of the monument, the latch being selected to have a failure load higher than the use threshold value and higher than the decompression threshold value; and configuring a striker plate of the latch assembly for connection to the second component of the monument and for selectively engaging the latch, the striker plate being configured to have a failure load higher than the use threshold value and lower than the decompression threshold value.

In particular embodiments, the method may include any one or any suitable combination of the following:
the striker plate has an opening defined therethrough, and configuring the striker plate includes defining at least one zone of weakness adjacent the opening, the at least one zone of weakness determining the failure load of the striker plate;
the opening in the striker plate is configured to receive and engage a latch bolt of the latch;
the opening in the striker plate is configured for receiving a fastener connecting the striker plate to the second component of the monument;
the striker plate has an opening defined therethrough, and configuring the striker plate includes defining two spaced apart zones of weakness adjacent the opening, the zones of weakness designed to determine the failure load of the striker plate;
defining the at least one zone of weakness includes reducing a thickness of a portion of the striker plate;
defining the at least one zone of weakness includes reducing a thickness of a cross-sectional area of a portion of the striker plate, the cross-sectional areas being defined in a plane containing a thickness of the striker plate.

### DESCRIPTION OF THE DRAWINGS

For a better understanding of the present invention, as well as other aspects and further features thereof, reference is made to the following description which is to be used in conjunction with the accompanying drawings, where:

FIG. 1 is a schematic tridimensional view of an exemplary aircraft;

FIG. 2 is a schematic tridimensional view of a monument in accordance with a particular embodiment, which can be received in the cabin of an aircraft such as shown in FIG. 1;

FIG. 3 is a schematic rear tridimensional view of a latch of the latch assembly of the monument of FIG. 2, in accordance with a particular embodiment;

FIG. 4 is a schematic tridimensional view of a striker plate of the latch assembly of the monument of FIG. 2, in accordance with a particular embodiment;

FIG. 5 is a schematic tridimensional view of the latch assembly including the latch of FIG. 3 and the striker plate of FIG. 4;

FIG. 6a is a schematic top view of a striker plate of the latch assembly of the monument of FIG. 2, in accordance with another particular embodiment;

FIG. 6b is a schematic side view of the striker plate of FIG. 6a;

FIG. 7 is a schematic top view of a striker plate of the latch assembly of the monument of FIG. 2, in accordance with another particular embodiment;

FIG. 8a is a schematic top view of a striker plate of the latch assembly of the monument of FIG. 2, in accordance with another particular embodiment;

FIG. 8b is a schematic side view of the striker plate of FIG. 8a;

FIG. 9a is a schematic top view of a striker plate of the latch assembly of the monument of FIG. 2, in accordance with another particular embodiment; and

FIG. 9b is a schematic side view of the striker plate of FIG. 9a.

In the drawings, embodiments of the invention are illustrated by way of example. It is to be expressly understood that the description and drawings are only for purposes of illustration and as an aid to understanding. They are not intended to be a definition of the limits of the invention.

### DETAILED DESCRIPTION

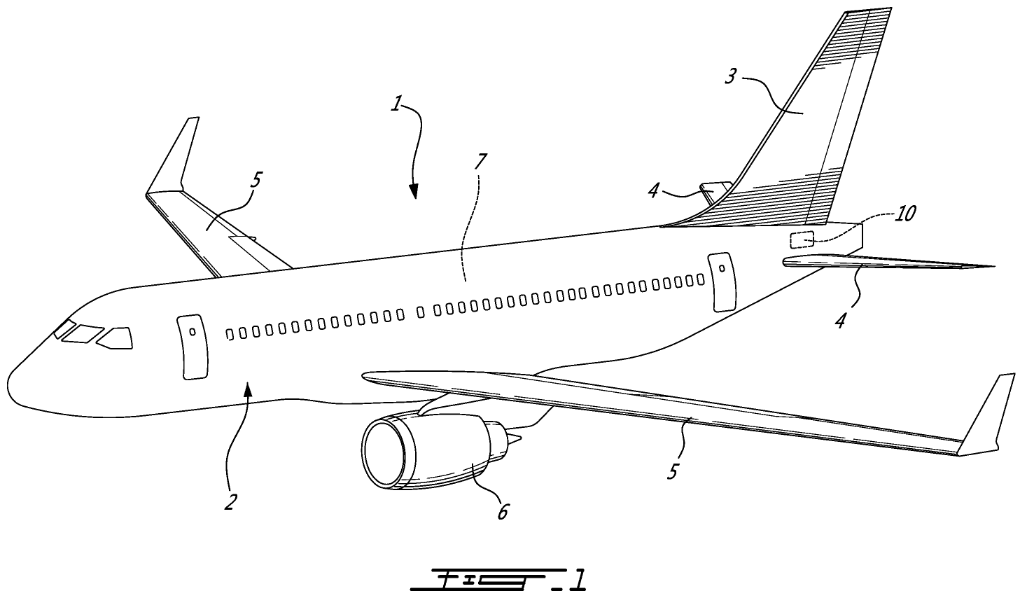

Referring to the drawings and more particularly to FIG. 1, an aircraft is shown at 1, and is generally described to illustrate some components for reference purposes in the present disclosure. The aircraft 1 has a fuselage 2 having a fore end at which a cockpit is located, and an aft end supporting a tail assembly, with the cabin 7 generally located between the cockpit and the tail assembly. The tail assembly comprises a vertical stabilizer 3 with a rudder, and horizontal stabilizers 4 with elevators. The tail assembly has a fuselage-mounted tail, but other configurations may also be used for the aircraft 1, such as cruciform, T-tail, etc. Wings 5 project laterally from the fuselage. The aircraft 1 has engines 6 supported by the wings 5, although the engines 6 could also be mounted to the fuselage 2. The aircraft 1 is shown as a jet-engine aircraft, but may also be a propeller aircraft. It is also understood that although FIG. 1 shows a commercial aircraft, the aircraft 1 may alternately be any other type of aircraft, including, but not limited to, a business aircraft or a private aircraft.

Monuments are received in the cabin 7 of the aircraft 1. Some of these monuments are selectively openable and closable for example through use of a drawer or a door; such monuments may include, but are not limited to, galleys, wardrobes, cabinets, vanities, credenzas, closets, avionic racks, and storage compartments. The monuments thus each include relatively movable components (e.g. drawer or door, and body of the monument) which are interconnected by one or more suitable connection members allowing for the relative movement (e.g. rail, hinge). In some instances, the relatively movable components must be selectively engageable with each other when in the closed configuration to prevent the relative movement, so as to be able to maintain the closed configuration.

Referring to FIG. 2, an example of such a monument 10 is partially shown, including a drawer 12 which is slidable with respect to a body 14 of the monument 10 attached to the aircraft structure. The drawer 12 has a box 16 for receiving contents, and a face panel 18 which defines the visible portion of the drawer 12 when in the closed position. The drawer box 16 is designed to receive a content having a predetermined maximum mass (e.g., 20 lbs; other values are also possible), which may be identified in a suitable manner on the drawer 12 for reference by the user, for example on the face panel 18. The drawer box 16 is received in a complementary opening 20 defined in the body 14 of the monument 10. The drawer box 16 is slidingly engaged to the body 14 of the monument 10, for example by rails 22 attached to the drawer box 16 and slidingly engaging a complementary member (not shown) attached to an interior surface of the body 14 of the monument 10. It is understood that the configuration shown is exemplary only, and that the monument 10 can have any suitable alternate configuration; as a non-limiting example, the relatively movable components may be a cabinet body and a cabinet door hingedly connected to the cabinet body.

The monument 10 includes a latch assembly 30 for selectively engaging the face panel 18 of the drawer 12 to the body 14 when in the closed position, so as to prevent the relative movement between the drawer 12 and the body 14 and retain the drawer 12 in the closed position. The latch assembly 30 generally includes a latch 32, shown here as being connected to the drawer 12, and a striker plate 34, shown here as being connected to the body 14 of the monument 10; it is understood that alternately, the latch 32 could be connected to the body 14 and the striker plate 34 to the drawer 12. The latch 32 and striker plate 34 include complementary connection members, which are selectively engageable to each other to retain the drawer 12 in the closed position.

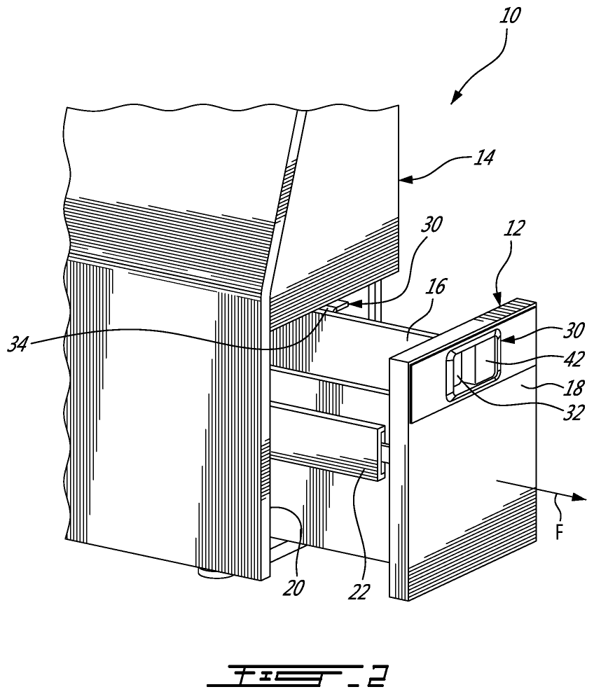

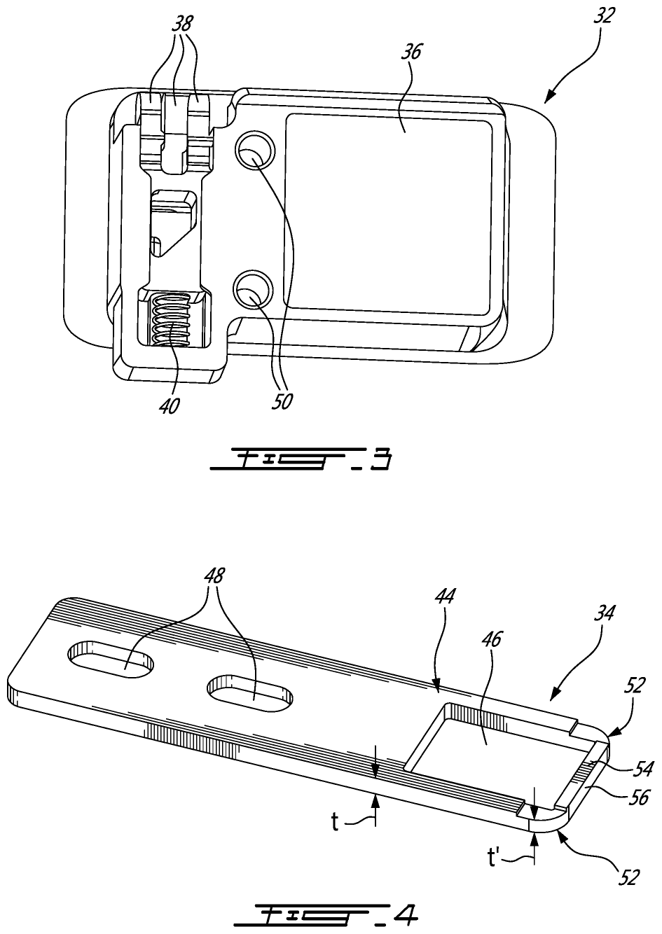

Referring to FIGS. 3-5, an exemplary embodiment of the latch assembly 30 is shown. In this embodiment, and as can be seen in FIGS. 3 and 5, the latch 32 includes a housing 36 and a latch bolt 38 defining the engagement member of the latch 32, movable with respect to the housing 36 between a retracted position (not shown) and an extended position (FIGS. 3 and 5). The latch bolt 38 is shown here as including three (3) interconnected members, but it is understood that any other suitable configuration can alternately be used. The latch bolt 38 is biased in the extended position, for example by a spring 40 (FIG. 3). The latch 32 includes an actuation member 42 (see FIG. 2) which, upon actuation by a user, moves the latch bolt 38 to the retracted position so as to allow disengagement of the latch 32 from the striker plate 34.

Referring to FIG. 3, the housing 36 has fastener openings 50 (FIG. 3) defined therein, each sized for receiving a suitable fastener (not shown) for connecting the latch 32 to the drawer 12 of the monument 10, for example by connecting the housing 36 to a back plate (not shown) with part of the drawer 12 being sandwiched, or clamped, between the housing 36 and back plate. Although two fastener openings 50 are shown, it is understood that any other suitable number of opening(s) may alternately be provided. Moreover, it is understood that the latch 32 can be engaged to the drawer 12 using any other suitable type of attachment, including, but not limited to, fasteners directly connecting the housing 36 to the drawer 12 without the need for a back plate, a suitable adhesive, a suitable clamping mechanism, or a hook and loop type of fastener, as long as the attachment provides for a suitable failure load, as will be described further below.

As can be seen in FIGS. 4-5, the engagement member of the striker plate 34 is defined by a portion 44 of the striker plate 34 having an opening 46 defined therethrough for receiving and engaging the latch bolt 38. Additional openings 48 are provided in the striker plate 34, each sized for receiving a suitable fastener (not shown) for connecting the striker plate 34 to the body 14 of the monument 10. Although two fastener openings 48 are shown, it is understood that any other suitable number of opening(s) may alternately be provided. Moreover, it is understood that the striker plate 34 can be engaged to the body 14 of the monument 10 using any other suitable type of attachment, including, but not limited to, a suitable adhesive, or a hook and loop type of fastener, as long as the attachment provides for a suitable failure load, as will be described further below.

In use, the engaged latch 32 and striker plate 34 (engagement between latch bolt 38 and perimeter of opening 46 in the embodiment shown) prevent the relative movement between the drawer 12 and the body 14 so as to maintain the drawer 12 in the closed position. The engaged latch 32 and striker plate 34 are subjected to a load, which in the example shown in FIG. 2 may be applied along a direction parallel to the rails 22, as illustrated by arrow F. A number of conditions may create a force tending to push the drawer 12 away from the body 14, i.e. toward its open position, and accordingly may affect the magnitude of the load F transferred to the engaged latch 32 and striker plate 34. The latch assembly 30 is designed to be able to retain the drawer 12 in its closed position when required, while allowing the drawer 12 to move to the open position when required.

For example, during use, the acceleration of the aircraft 1 can act on the contents of the drawer 12 to create a force tending to push the drawer 12 toward the open position. A use threshold value for the load transferred to the latch assembly 30 can be defined as the minimum value of the load that the latch assembly 30 must be able to resist so that the latch 32 and striker plate 34 remain engaged, e.g. the drawer 12 remains closed, during predetermined flight conditions, which may include for example emergency landing, various flight maneuvers and gusts. The use threshold value can be determined based on the mass of the movable portion of the monument 10 (e.g. drawer, door) in addition to the mass of the content of the monument 10, and on accelerations generated during these predetermined flight conditions. In a particular embodiment, the use threshold value corresponds to the load produced by the maximum movable mass (e.g. mass of drawer 12 plus predetermined maximum mass of content) undergoing an acceleration of 3G. Other values are also possible.

During a decompression event, the rapid decompression of the surrounding environment causes large pressure differentials between the environment and the monuments where the air cannot escape fast enough to equalize the pressure. The air pressure within the monument 10 thus tends to push the drawer 12 toward its open position. In this case, it is desirable for the drawer 12 to open and the air pressure within the monument 10 to equalize with that of the surrounding environment, so as to avoid greater damage that could be caused by the force created by the delta pressure on the monument 10. A decompression threshold value for the load transferred to the latch assembly 30 can be defined as the maximum value of the load that the latch assembly 30 must be able to resist. In other words, during decompression, the latch 32 and striker plate 34 become disengaged from each other and/or separate from one or both of the components of the monument 10 and/or break to allow the relative movement between the components of the monument 10 (e.g., opening of the drawer 12), when or before the decompression threshold value is reached. In a particular embodiment, the decompression threshold value is determined based on decompression pressure conditions for a specific aircraft (e.g. pressure differential, surface area of the monument on which the pressure differential produces a load).

The decompression threshold value is higher than the use threshold value. Examples of suitable values include for example a use threshold value of 150 lbf (668 N) and a decompression threshold value of 220 lbf (1000 N) for a wardrobe with a door; a use threshold value of 380 lbf (1690 N) and a decompression threshold value of 600 lbf (2669 N) for a galley with a full length door; and a use threshold value of 200 lbf (891 N) and a decompression threshold value of 270 lbf (1201 N) for galley with a partition door, a galley with a drawer, or a storage unit with a door. It is understood that these values are provided as an example only, and that any other suitable value can alternately be used. Suitable values can be determined by the person of ordinary skill based for example on the dimensions of the monument, mass of the content and of the movable portion of the monument, configuration of the aircraft, pressure conditions, and accelerations produced during flight.

The striker plate 34 has a failure load corresponding to the value of the load upon failure of the striker plate 34 when its engagement member is subjected to the load created by the contents of the monument 10, and the latch 32 also has a failure load corresponding to the value of the load upon failure of the latch 32 when its engagement member is subjected to the load created by the contents of the monument 10. As used herein, the term “failure load” refers to the load at which the element (striker plate 34, latch 32) breaks or becomes otherwise unable to perform its function, so that the components 12, 14 of the monument 10 become free to move away from each other without the latch assembly 30 being actuated by a user or by any other type of actuation mechanism. For example, the failure load of the striker plate 34 can be the load at which the portion 44 of the striker plate 34 engaged to the latch 32 breaks away from the latch 32, the load at which the portion of the striker plate 34 engaged to its component (e.g. body 14) of the monument 10 breaks away from its component of the monument 10, or the load at which the portion 44 of the striker plate 34 engaged to the latch 32 breaks away from the remainder of the striker plate 34, whichever happens first. The failure load of the latch 32 can be the load at the failure of any element of the internal mechanism of the latch 32 causing the latch bolt 38 to separate from the housing 36, or the load at which the latch bolt 38 breaks away from the striker plate 34, or the load at which the portion of the latch 32 engaged to its component (e.g. drawer 12) of the monument 10 breaks away from its component of the monument 10, whichever happens first.

Prior art latch assemblies typically have a relatively strong striker plate and a relatively weak latch, and accordingly often fail at the latch during a decompression event. A latch includes multiple moving parts which interact with each other, and accordingly the type of failure and failure load of a latch usually cannot be easily predicted or calculated; typically, the failure load of a latch is determined through testing, and several iterations of modifications and testing can be required to obtain a desired failure load. Moreover, since different monuments in a cabin can have different sizes and/or be designed for different contents, the different monuments can have different use threshold values and/or decompression threshold values from each other. Thus, different latches may be required for the different monuments, and these different latches need to be individually tested to ensure that each latch provides the required failure load. This process can be complex, time consuming and/or costly.

By contrast, the latch 32 of the present latch assembly 30 has a failure load which is higher than both the use threshold value and the decompression threshold value. The latch 32 is thus able to resist the loads applied to the latch assembly 30 both during predetermined flight conditions (e.g., “normal” flight, emergency landing, and gusts) and during decompression. The striker plate 34 is however configured and designed to have a predetermined failure load which is higher than the use threshold value, but lower than the decompression threshold value. In other words, the failure load of the striker plate 34 is tailored and selected through appropriate design of the striker plate 34 so as to have a value between the use and decompression threshold values. Accordingly, the striker plate 34 is able to resist the loads applied to the latch assembly 30 during the predetermined flight conditions, but breaks or otherwise causes the latch assembly 30 to become unable to maintain the engagement between the components of the monument during decompression. Failure of the latch assembly 30 as a whole during decompression thus occurs in the striker plate 34.

In a particular embodiment, this allows for the failure of the latch assembly 30 as a whole to be tailored in a relatively easy manner. The latch 32 can be designed and/or selected to be very strong without consideration of the need for failure during decompression, which in a particular embodiment allows for easier selection of latches to be provided with different monuments subjected to loads having different use threshold values and/or decompression threshold values. Since the geometry of the striker plate 34 is simple, its failure mode(s) is/are predictable, and can be calculated; the striker plate 34 can thus be designed to have a predetermined failure load between the use and decompression thresholds. Accordingly, failure of the latch assembly 30 as a whole can be predicted, calculated, and changed as required through modifications in the design (e.g. geometry and/or materials) of the striker plate 34 to change its failure load, without the need for modifications to the latch 32. Variations in design and/or customer requirements can be easier to accommodate, and in some embodiments can be performed without retesting since the failure load of the striker plate 34 can be accurately calculated, predicted, and tailored through suitable design of the striker plate 34.

In the embodiment shown and referring to FIGS. 4-5, the striker plate 34 includes two zones of weakness 52 which are designed to determine the failure load of the striker plate 34, i.e., which define the weakest points of the striker plate 34. In this embodiment, the opening 46 for engaging the latch bolt 38 has a rectangular shape, and extends at one end of the elongated striker plate 34. The end of the striker plate 34 defines an edge portion 54 between the opening 46 and the edge 56 of the striker plate 34; as can be best seen in FIG. 5, the edge portion 54 abuts the latch bolt 38 when the striker plate 34 and latch 32 are engaged, and the latch bolt 38 presses against the edge portion 54 when the load F tending to move the drawer 12 toward the open position is applied to the latch assembly 30. The zones of weakness 52 are defined at the opposed ends of the edge portion 54, i.e. at the corners of the end of the striker plate 34. Upon breaking of one or both of the zones of weakness 52, the edge portion 54 separates from the remainder of the striker plate 34 and the latch bolt 38 is free to exit the opening 46 along the direction of the load F.

In the embodiment shown, the zones of weakness 52 are each formed by a notch extending from the opening 46 to the edge 56 of the striker plate 34. The thickness t of the striker plate 34 is accordingly reduced to a smaller thickness t′ in the notch. In the embodiment shown, the smallest thickness of the striker plate 34 is defined by the notches 52.

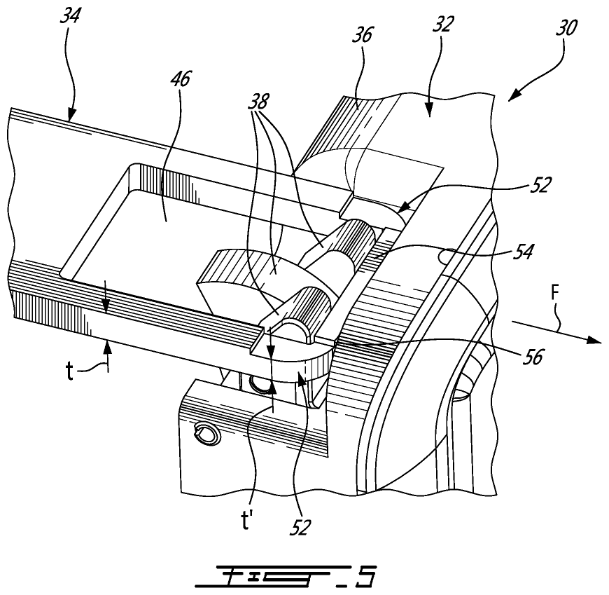

It is understood that the zone(s) of weakness 52 can have any other suitable configuration. FIGS. 6a-6b and 7 show alternate configurations for the zone(s) of weakness provided in the striker plate 34; any other suitable configuration may alternately be used. For example, any one of or any combination of the dimensions identified in FIGS. 6a-6b (a, a′, b, d, e, f, g, t) may be modified to create a zone of weakness defining the failure load of the striker plate 34. As illustrated in FIG. 6a, the width a, a′, b of any of the edge portions 54, 54′ bordering the opening 46 for engaging the latch bolt 38 can be reduced, for example so as to create a zone of weakness having a cross-sectional area smaller than that of the remaining portions of the striker plate 34, as defined in a plane containing the thickness of the striker plate, e.g. longitudinal plane L (dimension b) or transversal plane T (dimensions a, a′). As illustrated in FIG. 6b, the thickness t of the striker plate 34 can also be reduced in any of these locations 54, 54′ to create the zone of weakness. Such zones of weakness cause the striker plate 34 to break at its engagement with the latch bolt 38, thus allowing the latch bolt 38 and striker plate 34 to disengage from each other so as to allow relative movement between the components 12, 14 of the monument 10.

Referring back to FIG. 6a, the width d, e, f of any of the edge portions 58 bordering the fastener opening(s) 48 can be reduced, and/or the width g of the portion 60 between adjacent fastener openings 48 can be reduced, so as to create a zone of weakness adjacent the fastener opening(s) 48, for example having a cross-sectional area smaller than that of the remaining portions of the striker plate 34, as defined in longitudinal plane L (dimensions f, g) or transversal plane T (dimensions d, e). The thickness t (FIG. 6b) can also be reduced in any of these locations 58, 58′, 60 to create the zone of weakness. Such zones of weakness cause the striker plate 34 to break at its engagement with its component of the monument (e.g. monument body 14), thus allowing the striker plate 34 to disengage from its component of the monument so as to allow relative movement between the components 12, 14 of the monument 10.

Referring to FIG. 7, in alternate embodiments the thickness t can be reduced at any of these locations without changing the other dimensions, by providing one or more notches to create the zone(s) of weakness, for example similarly to the embodiment shown in FIGS. 4-5. Example of notches are shown as extending between the edge 56 of the striker plate 34 and the opening 46 for engaging the latch bolt 38 (notches A, A′, B), so as to define zone(s) of weakness causing the striker plate 34 to fail by becoming disengaged from the latch 32; extending between the edge 56 of the striker plate 34 and one of the fastener openings 48 (notches D, E, F) or between the fastener openings 48 (notch G), so as to define zone(s) of weakness causing the striker plate 34 to fail by becoming disengaged from its component 14 of the monument 10; or between opposed edges 56 of the striker plate 34, intermediate the opening 46 for engaging the latch bolt 38 and the fastener openings 48 (notch C), so as to define zone(s) of weakness causing the striker plate 34 to fail by having the portion 44 of the striker plate 34 engaged to the latch 32 to breaking away from the remainder of the striker plate 34 engaged to the component 14 of the monument 10.

It is understood that any other suitable configuration for the zone(s) of weakness can alternately be used.

In another embodiment, the striker plate 34 is configured to have the desired failure load through selection of materials. For example, a weaker material is used to manufacture the striker plate 34 without changing its configuration, so as to reduce the failure load to a desired value. Zone(s) of weakness determining the failure load can be defined by the geometry of the striker plate 34 (e.g. sections with the smallest cross-sectional areas and/or thicknesses).

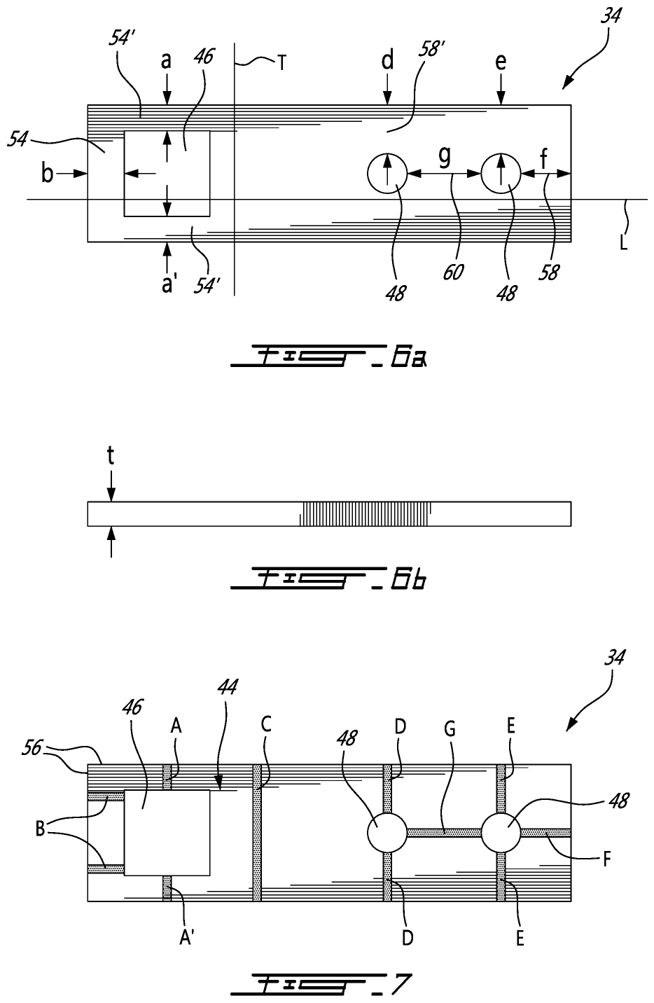

It is understood that the configuration of the striker plate 34 shown is exemplary only, and that variations are possible. For example, referring to FIGS. 8a-8b, a striker plate 134 according to another embodiment is shown, where similar elements are designated by the same reference numerals and will not be further described herein. The striker plate 134 of FIGS. 8a-8b differs from the striker plate 34 of FIGS. 4-5 in that the edge portion 154 at the end of the striker plate 134 forms a hook 162; in this case the latch (not shown) does not include a latch bolt but a connection member suitable to engage the hook. Although an opening 146 is provided adjacent the hook 162, the opening 146 is not configured to engage a latch bolt but is provided to allow the creation of one or more zone(s) of weakness, which can be defined for example in any of the locations and with any of the configurations set forth above and shown in FIGS. 4-5, 6a-6b and 7.

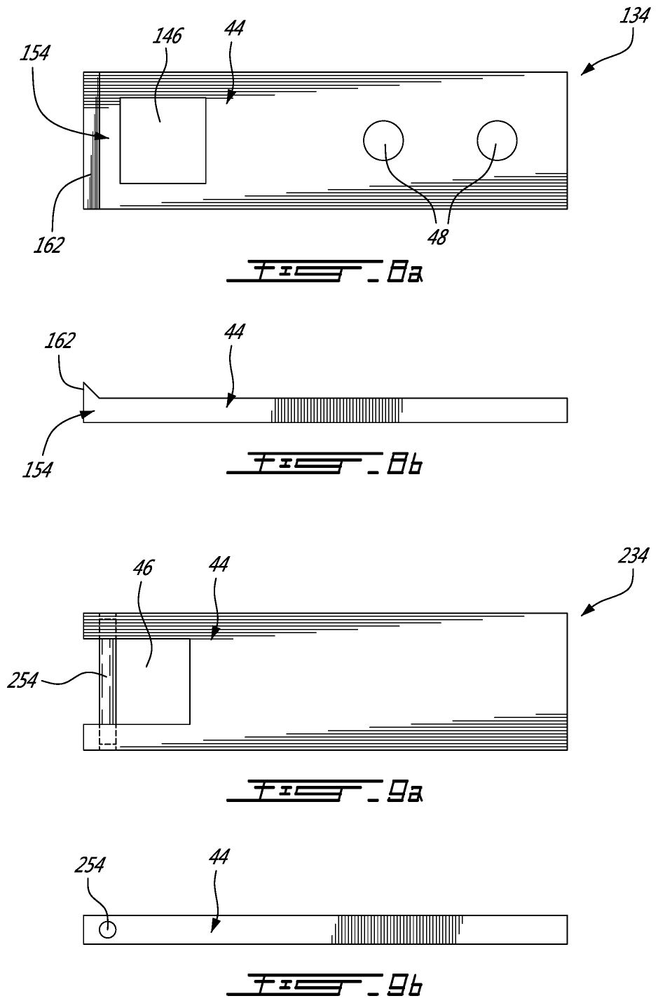

FIGS. 9a-9b show a striker plate 234 according to yet another embodiment, again where similar elements are designated by the same reference numerals and will not be further described herein. This embodiment is configured to engage a latch bolt 38 and accordingly includes an opening 46 for that purpose. However, the edge portion 254 adjacent the opening 46 for engaging the latch bolt 38 is defined by a rod formed separately from and attached to the remainder of the striker plate 34. The rod 254 can have any suitable cross-sectional shape, including, but not limited to, circular, rectangular and square. The zone(s) of weakness can be provided at any suitable location and with any suitable configuration, for example in any of the locations and with any of the configurations set forth above and shown in FIGS. 4-5, 6a-6b and 7. The zone(s) of weakness can be provided within the rod 254, within the remainder of the striker plate 234, or at the junction(s)/connection(s) between the rod 254 and the remainder of the striker plate 234. Although no fastener openings are shown, it is understood that the striker plate 234 can have any suitable number of fastener opening(s) defined therethrough.

It is also understood that any other suitable configuration for the striker plate 34, 134, 234 can alternately be used.

In use, the failure of the latch assembly 30 can thus be tailored by determining the use threshold value of the load applied to the latch assembly 30 during predetermined flight conditions, for example based on the movable mass of the monument 10 and on accelerations generated by the predetermined flight conditions, and determining the decompression threshold value of the load applied to the latch assembly 30, for example based on decompression pressure conditions. The latch 32 of the latch assembly 30 is selected so as to have a failure load higher than the use threshold value and higher than the decompression threshold value. In a particular embodiment, this allows for a latch 32 strong enough to resist the highest loads across all the monuments 10 in the cabin to be selected and used for all the monuments 10, which may simplify the procurement and/or installation of parts.

The striker plate 34, 134, 234 for each monument 10 is then configured for selectively engaging the respective latch 32 and to have a failure load higher than the use threshold value but lower than the decompression threshold value of the respective monument 10. Thus, monuments 10 subjected to loads having different use threshold values and/or decompression threshold values can have the same latch 32 but different striker plates 34, 134, 234 tailored to provide the particular failure load required for each monument 10.

As described above, in a particular embodiment configuring the striker plate 34, 134, 234 includes defining one or more zone(s) of weakness 52 adjacent one of the openings 46, 48, 146 of the striker plate, so that the zone(s) of weakness determine the failure load of the striker plate 34, 134, 234. The zone(s) of weakness 52 can be configured, for example, by reducing a thickness t and/or a cross-sectional area (for example by reducing the width a, b, d, e, f, g) in a portion 54, 54′, 58, 58′, 60, A, B, C, D, E, F, G of the striker plate 34, 134, 234.

In a particular embodiment, the zone(s) of weakness 52 are designed within the striker plate 34, 134, 234 based on calculations. The zone(s) of weakness 52 are sized mathematically, based on the properties of the material(s) of the striker plate 34, 134, 234 and on the geometry of the striker plate 34, 134, 234, so as to have a failure load greater than the use threshold but lower than the decompression threshold. In a particular embodiment, this avoids expensive and time consuming testing, and may allow for example to determine compliance with certification authority requirements based on calculations and without the need for tests.

While the methods and systems described herein have been described and shown with reference to particular steps performed in a particular order, it will be understood that these steps may be combined, sub-divided or reordered to form an equivalent method without departing from the teachings of the present invention. Accordingly, the order and grouping of the steps is not a limitation of the present invention.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

1. A latch assembly for selectively preventing a relative movement between first and second components of an aircraft cabin monument, the latch assembly comprising:
a latch configured for connection to the first component, the latch having a first connection member; and
a striker plate configured for connection to the second component, the striker plate having a second connection member complementary to the first connection member and selectively engageable with the first connection member;
wherein the engaged latch and striker plate in use are subjected to a load having a use threshold value determined based on a movable mass of the monument and on accelerations generated by predetermined flight conditions, and having a decompression threshold value determined based on decompression pressure conditions;
wherein the striker plate is designed to have a predetermined first failure load corresponding to a value of the load upon failure of the striker plate when the first engagement member is subjected to the load, the first failure load being higher than the use threshold value and lower than the decompression threshold value; and
wherein the latch has a second failure load corresponding to a value of the load upon failure of the latch when the second engagement member is subjected to the load, the second failure load being higher than the use threshold value and higher than the decompression threshold value.

2. The latch assembly as defined in claim 1, wherein the striker plate has an opening defined therethrough, the striker plate including at least one zone of weakness adjacent the opening, the at least one zone of weakness determining the first failure load.

3. The latch assembly as defined in claim 2, wherein the first connection member of the latch is a latch bolt movable with respect to a housing of the latch, and the second connection member of the striker plate has the opening defined therethrough, the latch bolt engageable within the opening.

4. The latch assembly as defined in claim 2, wherein the opening in the striker plate is configured for receiving a fastener for connecting the striker plate to the second component of the monument.

5. The latch assembly as defined in claim 2, wherein the opening is defined adjacent an edge of the striker plate, the striker plate including an edge portion extending between the edge and the opening, the at least one zone of weakness including two spaced apart zones of weakness defined at opposed ends of the edge portion.

6. The latch assembly as defined in claim 6, wherein each of the two spaced apart zones of weakness is defined by a notch in the striker plate, each notch extending from the opening to the edge of the striker plate.

7. The latch assembly as defined in claim 2, wherein the at least one zone of weakness includes a portion of the striker plate having a thickness smaller than a thickness of a remainder of the striker plate.

8. The latch assembly as defined in claim 2, wherein the at least one zone of weakness includes a portion of the striker plate having a cross-sectional area smaller than a cross-sectional area of a remainder of the striker plate, the cross-sectional areas being defined in a plane containing a thickness of the striker plate.

9. A latch assembly for selectively preventing a relative movement between first and second components of an aircraft cabin monument, the latch assembly comprising:
a latch configured for connection to the first component, the latch having a housing and a latch bolt movable with respect to the housing; and
a striker plate configured for connection to the second component, the striker plate having an opening defined therethrough, the latch bolt selectively receivable and engageable within the opening;
wherein each of the latch and striker plate has a respective failure load with respect to a load transferred to the latch and striker plate when the latch bolt is engaged in the opening and the first and second components are forced away from each other;
wherein the striker plate has at least one zone of weakness designed to determine the failure load of the striker plate; and
wherein the failure load of the striker plate is smaller than the failure load of the latch.

10. The latch assembly as defined in claim 9, wherein the opening is defined adjacent an edge of the striker plate, the striker plate including an edge portion extending between the edge and the opening, the at least one zone of weakness being adjacent the opening.

11. The latch assembly as defined in claim 10, wherein the at least one zone of weakness includes two spaced apart zones of weakness defined at opposed ends of the edge portion.

12. The latch assembly as defined in claim 10, wherein each of the two spaced apart zones of weakness is defined by a notch in the striker plate, each notch extending from the opening to the edge of the striker plate.

13. The latch assembly as defined in claim 9, wherein the at least one zone of weakness includes a portion of the striker plate having a thickness smaller than a thickness of a remainder of the striker plate.

14. The latch assembly as defined in claim 9, wherein the at least one zone of weakness includes a portion of the striker plate having a cross-sectional area smaller than a cross-sectional area of a remainder of the striker plate, the cross-sectional areas being defined in a plane containing a thickness of the striker plate.

15. A method of tailoring a failure of a latch assembly selectively preventing a relative movement between first and second components of an aircraft cabin monument, the method comprising:
determining a use threshold value of a load applied to the latch assembly during predetermined flight conditions based on a movable mass of the monument and on accelerations generated by the predetermined flight conditions;
determining a decompression threshold value of the load applied to the latch assembly based on decompression pressure conditions;
selecting a latch of the latch assembly for connection to the first component of the monument, the latch being selected to have a failure load higher than the use threshold value and higher than the decompression threshold value; and
configuring a striker plate of the latch assembly for connection to the second component of the monument and for selectively engaging the latch, the striker plate being configured to have a failure load higher than the use threshold value and lower than the decompression threshold value.

16. The method as defined in claim 15, wherein the striker plate has an opening defined therethrough, and configuring the striker plate includes defining at least one zone of weakness adjacent the opening, the at least one zone of weakness determining the failure load of the striker plate.

17. The method as defined in claim 16, wherein the opening in the striker plate is configured to receive and engage a latch bolt of the latch.

18. The method as defined in claim 16, wherein the opening in the striker plate is configured for receiving a fastener connecting the striker plate to the second component of the monument.

19. The method as defined in claim 15, wherein the striker plate has an opening defined therethrough, and configuring the striker plate includes defining two spaced apart zones of weakness adjacent the opening, the zones of weakness designed to determine the failure load of the striker plate.

20. The method as defined in claim 16, wherein defining the at least one zone of weakness includes reducing a thickness of a portion of the striker plate.

21. The method as defined in claim 16, wherein defining the at least one zone of weakness includes reducing a thickness of a cross-sectional area of a portion of the striker plate, the cross-sectional areas being defined in a plane containing a thickness of the striker plate.
